(19) United States
(12) Patent Application Publication
(10) Pub. No.: US 2011/0120790 A1
(43) Pub. Date: May 26, 2011

(54) METHOD FOR OPERATING A DRIVE TRAIN

(75) Inventors: Bernd Allgaier, Kressbronn (DE); Friedrich Tenbrock, Langenargen (DE); Michael Gromus, Eriskirch (DE)

(73) Assignee: ZF FRIEDRICHSHAFEN AG, Friedrichshafen (DE)

(21) Appl. No.: 13/055,282

(22) PCT Filed: Jul. 16, 2009
(86) PCT No.: PCT/EP09/59164

§ 371 Date: Jan. 21, 2011

(30) Foreign Application Priority Data
Jul. 24, 2008 (DE) 10 2008 040 661.9

(51) Int. Cl. B60W 20/00; B60W 10/06; B60W 10/08; B60W 10/02

(52) U.S. Cl. 180/65.265; 180/65.28; 180/65.285; 903/902

(57) ABSTRACT

A method for operating a drive train of a motor vehicle comprising a hybrid drive including a combustion engine and electric motor, a clutch connected between the engine and motor, a transmission arranged between the hybrid drive and a drive output, and a transmission starting element. The method comprises the steps of engaging the clutch, from its fully disengaged condition, into a slipping condition and disengaging the starting element, starting from a fully engaged condition, into a slipping condition. Once the engine begins rotation, the clutch is maintained in the slipping condition until the rotational speeds of the engine and the motor correspond with one another. Then the clutch is completely engaged; the transmission starting element, from the slipping condition, is completely re-engaged when a difference between the drive output speed and the engine or electric motor speed reaches or exceeds a specified value.

This application is a National Stage completion of PCT/EP2009/059164 filed Jul. 16, 2009, which clams priority from German patent application serial no. 10 2008 040 661.9 filed Jul. 24, 2008.

### FIELD OF THE INVENTION

The invention concerns a method for operating a drive train of a motor vehicle that comprises, as a minimum, a transmission and a hybrid drive.

### BACKGROUND OF THE INVENTION

The main components of a drive train of a motor vehicle are a drive unit and a transmission. The transmission converts torques and speeds so as to transform the traction force provided by the drive unit. The present invention concerns a method for operating a drive train that comprises, as a minimum, a transmission and, as the drive unit, a hybrid drive with an internal combustion engine and an electric motor.

FIG. 1 shows a drive train layout known from the prior art for a drive train with a hybrid drive comprising an internal combustion engine 1 and an electric motor 2. A transmission 3 transforms the traction force produced by the hybrid drive and delivers it to a drive output 4. In FIG. 1 a clutch 5 is connected between the internal combustion engine 1 and the electric motor 2. In addition, in FIG. 1 a transmission-external starting element 6 is connected between the electric motor 2 and the transmission 3. Instead of a transmission-external starting element 6, there can also be a transmission-internal starting element. The structure of a drive train with a hybrid drive shown in FIG. 1 is also referred to as a parallel hybrid drive train.

When the drive train shown in FIG. 1 is operating under purely electric drive power, the clutch 5 between the internal combustion engine 1 and the electric motor 2 is disengaged, the internal combustion engine 1 is then preferably switched off and static. Starting from such a purely electric driving condition, if the internal combustion engine 1 is to be started and the drive train changed from purely electric motor-powered to hybrid driving, the procedure adopted until now is that which is shown in FIG. 2.

In FIG. 2 a total of three time variations of rotational speed n are plotted, namely an internal combustion engine speed n_{VM}, an electric motor speed n_{EM} and a drive output or transmission output speed n_{AB}. According to the prior art, to start up the internal combustion engine 1 and change from purely electric to hybrid driving operation, the procedure adopted according to FIG. 2 is that at a time t₁ the originally fully disengaged clutch 5, which is connected between the internal combustion engine 1 and the electric motor 2, is partially engaged to a slipping condition in which the clutch 5 is transmitting a defined clutch torque. Then, when the speed n_{VM} of the internal combustion engine 1 reaches a pre-defined speed n₂ at time t₂, according to the prior art the clutch 5 is disengaged farther again so that it transmits a lower clutch torque or none at all, and at time t₃, when the speed n_{VM} of the internal combustion engine 1 reaches the speed n_{EM} of the electric motor 2, the clutch 5 is again engaged farther to a slipping condition where it again transmits a higher clutch torque. Only at time t₄ is the clutch 5 completely engaged, so that from time t₄ onwards the speed n_{VM} of the internal combustion engine 1 is equal to the speed n_{EM} of the electric motor 2. Between the times t₁ and t₅, starting from an originally completely engaged condition the transmission-external or transmission-internal starting element 6 is disengaged or left engaged in a slipping condition and is held there, and at time t5 the transmission-internal or transmission-external starting element 6 is completely engaged again. This method for operating a drive train, known from the prior art, allows the internal combustion engine 1 to be started up so that the drive train is changed from purely electric motor-powered driving to hybrid driving, with great comfort and minimal reactive effects on the drive output 4.

However, there is need for a method for operating a drive train of this type with which, particularly when sporty driving behavior is desired, the internal combustion engine can be started up and the drive train changed from purely electric motor-powered driving to hybrid driving in a more dynamic manner.

### SUMMARY OF THE INVENTION

Starting from this, the present invention addresses the problem of providing a new type of method for operating a drive train that comprises a transmission and a hybrid drive.

According to the invention, the method comprises at least the following steps: a) to drag-start the internal combustion engine with the help of the electric motor, starting from a fully disengaged condition the clutch connected between the internal combustion engine and the electric motor is partially engaged to a slipping condition and, starting from a slipping condition, the transmission-internal or transmission-external starting element is disengaged farther, or from a fully engaged condition it is disengaged as far as a slipping condition; b) once the internal combustion engine has been started, the clutch connected between the internal combustion engine and the electric motor remains engaged as far as its slipping condition until the speed of the internal combustion engine corresponds approximately to the speed of the electric motor, and immediately thereafter the clutch between the internal combustion engine and the electric motor is engaged fully; c) after the clutch between the internal combustion engine and the electric motor has been fully engaged, starting from the slipping condition the transmission-internal or transmission-external starting element is fully disengaged again, when a speed difference between a drive output speed and the internal combustion engine speed or electric motor speed reaches or exceeds a specified value.

The method according to the invention enables the internal combustion engine to be started up and the drive train to be changed from purely electric motor-powered driving, in a more dynamic manner. With the help of the method according to the invention the internal combustion engine is accelerated with a higher speed gradient, and when the speed of the internal combustion engine corresponds approximately to that of the electric motor, the clutch connected between the internal combustion engine and the electric motor is engaged fully and rapidly.

This increases the slip at the transmission-internal or transmission-external starting element, and the increased speed difference on engaging the slipping starting element is used to supply a larger torque at the drive output. In this way all of the energy available can be provided as drive output torque.

### BRIEF DESCRIPTION OF THE DRAWINGS

Preferred further developments of the invention emerge from the description given below. Example embodiments of the invention, to which it is not limited, are explained in more detail with reference to the drawing, which shows:

FIG. 1: Drive train layout in a motor vehicle, with which the method according to the invention can be implemented;

FIG. 2: Diagram to illustrate the prior art;

FIG. 3: Diagram to illustrate the method according to the invention

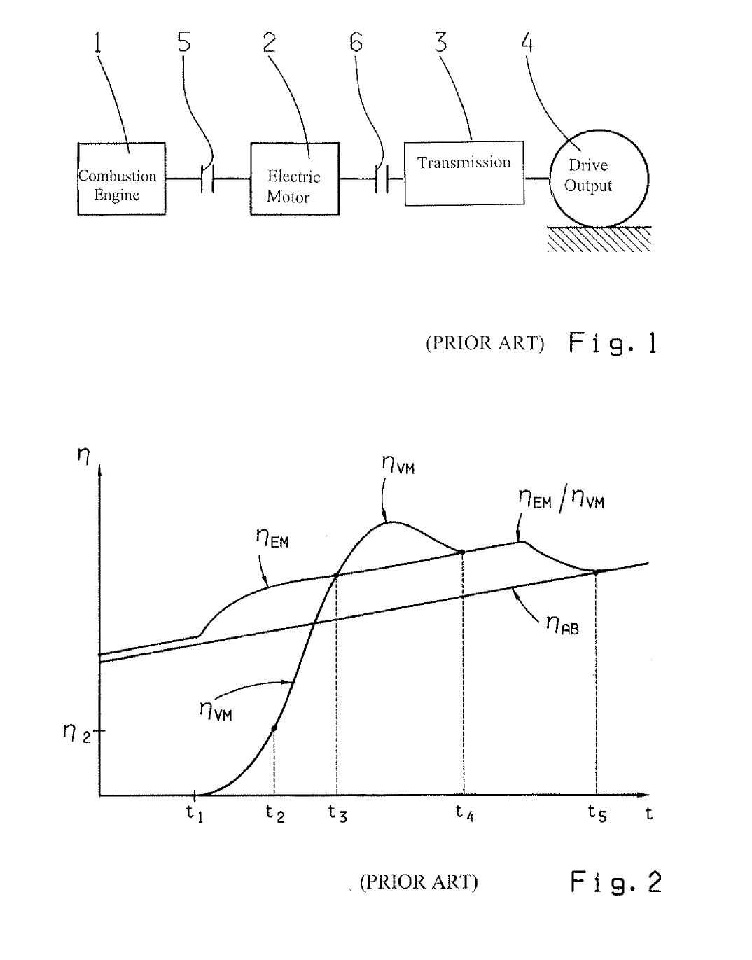

### DETAILED DESCRIPTION OF THE PREFERRED EMBODIMENTS

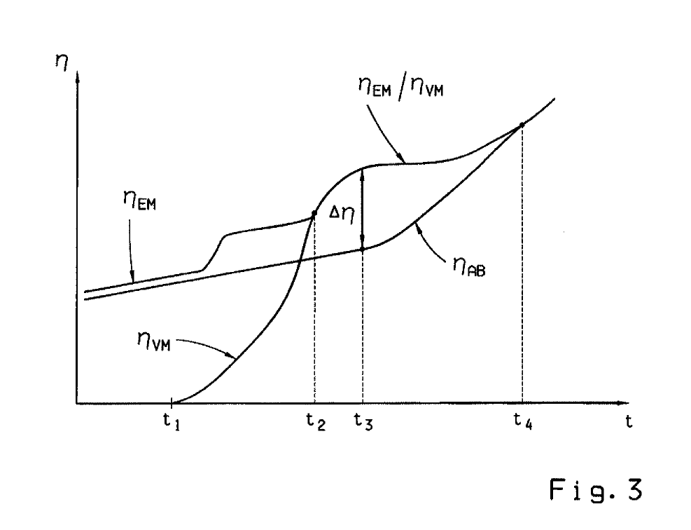

FIG. 3 illustrates the procedure according to the invention for starting the internal combustion engine 1 with the help of the electric motor 2 to change the drive train from purely electric motor-powered driving to hybrid driving.

In the context of the method according to the invention, when the originally static internal combustion engine 1 is to be drag-started, at a time t₁ the clutch 5 connected between the internal combustion engine 1 and the electric motor 2, beginning from a fully disengaged condition, is partially engaged as far as a slipping condition such that it transmits a defined clutch torque. To drag-start the internal combustion engine, at time t₁ the transmission-internal or transmission-external starting element 6 is disengaged from the fully engaged condition as far as a slipping condition such that the starting element 6 can transmit, as a torque, just the drive output torque desired by the driver.

Once the internal combustion engine 1 has been set into motion, in the method according to the invention the clutch 5 connected between the internal combustion engine 1 and the electric motor 2 is engaged to a slipping condition until, at a time t₂, the speed of the internal combustion engine 1 corresponds to that of the electric motor 2, and immediately thereafter the clutch 5 between the internal combustion engine 1 and the electric motor 2 is engaged completely and rapidly. Thus, in the method according to the invention the clutch 5 between the internal combustion engine 1 and the electric motor 2 is fully engaged from time t₂, so that the speed n_{VM} of the internal combustion engine 1 is equal to the speed n_{EM} of the electric motor 2.

During the time points t₁ and t₂ the clutch 5 between the internal combustion engine 1 and the electric motor 2 can remain unchanged in its slipping condition, so that even after the internal combustion engine 1 has been set into motion the clutch still transmits a clutch torque that corresponds to the clutch torque set in order to start up the internal combustion engine 1.

In contrast, however, it is also possible for the clutch 5 connected between the internal combustion engine 1 and the electric motor 2 to be engaged farther, while still slipping, so that it transmits a clutch torque greater than the clutch torque specified for setting the internal combustion engine 1 into motion.

During times t₁ and t₂ the transmission-internal or transmission-external starting element 6 remains unchanged in its slipping condition, so that it can transmit to the drive output just that drive output torque desired by the driver.

The engaging of the clutch 5 connected between the internal combustion engine 1 and the electric motor 2 at time t₂ brings about an increase of the slip of the transmission-internal or transmission-external starting element 6 and, when at time t₃ a slip or speed difference Δn between the drive output speed n_{AB} and the internal combustion engine speed n_{VM} or electric motor speed n_{EM} reaches or exceeds a specified value, in particular a specified maximum nominal value, the transmission-internal or transmission-external starting element 6 is again changed to the fully engaged condition in order to reduce the slip or speed difference, so that at time t₄ the speed difference or slip at the starting element 6 has been completely eliminated.

The increased slip at the starting element 6 is transferred to the drive output 4 so that a higher torque can be provided at the drive output 4. In this way the dynamics and sportiness of the entire process can be increased compared with the prior art.

### Indexes

1 Internal combustion engine
2 Electric motor
3 Transmission
4 Drive output
5 Clutch
6 Clutch/starting element

1-7. (canceled)

8. A method of operating a drive train of a motor vehicle, at a minimum the drive train comprising a hybrid drive with an internal combustion engine and an electric motor, a clutch being connected between the internal combustion engine and the electric motor, a transmission being arranged between the hybrid drive and a drive output, and having one of a transmission-internal and a transmission-external starting element, the method comprising the steps of:
a) drag-starting the internal combustion engine with assistance of the electric motor by engaging the clutch connected between the internal combustion engine and the electric motor, starting from its fully disengaged condition, as far as a slipping condition and one of:
further disengaging the transmission-internal or the transmission-external starting element into a slipping condition, when starting from a slipping condition, or
disengaging the transmission-internal or the transmission-external starting element starting to a slipping condition, when starting from a fully engaged condition;
b) maintaining the clutch between the internal combustion engine and the electric motor in the slipping condition, once the internal combustion engine is set in motion, until the speed of the internal combustion engine approximately corresponds to the speed of the electric motor, and immediately thereafter, completely engaging the clutch between the internal combustion engine and the electric motor; and
c) completely engaging the transmission-internal or the transmission-external starting element, starting from its slipping condition, after the clutch between the internal combustion engine and the electric motor is completely engaged, when a speed difference between a drive output speed and the speed of one of the internal combustion engine and the electric motor at least reaches a specified value.

9. The method according to claim 8, further comprising the step of engaging, during step a), the clutch connected between the internal combustion engine and the electric motor, starting from its fully disengaged condition, as far as a slipping condition where the clutch transmits a specified clutch torque.

10. The method according to claim 9, further comprising the step of maintaining engagement, during step b), of the clutch connected between the internal combustion engine and the electric motor and slipping in the condition in which the clutch transmits the specified clutch torque of step a) unchanged.

11. The method according to claim 9, further comprising the step of further engaging, during step b), the clutch connected between the internal combustion engine and the electric motor while still slipping, to a condition in which the clutch transmits a clutch torque greater than the specified clutch torque of step a).

12. The method according to claim 8, further comprising the step of disengaging, during step a), the transmission-internal or the transmission-external starting element starting from either the slipping condition, or from the fully engaged condition as far as a slipping condition where the transmission-internal or the transmission-external starting element transmits a torque that corresponds to a drive output torque desired by a driver.

13. The method according to claim 12, further comprising the step of keeping the transmission-internal or the transmission-external starting element engaged, during step b), as far as its slipping condition, such that the transmission-internal or the transmission-external starting it transmits unchanged torque that corresponds to the drive output torque desired by the driver.

14. The method according to claim 8, further comprising the step of completely re-engaging the transmission-internal or the transmission-external starting element, during step c), starting from the slipping condition, when a speed difference between a drive output speed and the speed of either the internal combustion engine or the electric motor at least reaches a specified maximum nominal value.

15. A method of operating a drive train of a motor vehicle to drag-start an internal combustion engine, the drive train comprising a hybrid drive having the internal combustion engine and an electric motor, a clutch being connected between the internal combustion engine and the electric motor, a transmission being arranged between the hybrid drive and a drive output, and a transmission starting element, the method comprising the steps of:
engaging the clutch from a fully disengaged condition to a slipping condition and disengaging the transmission starting element to a slipping condition to initiate rotation of the internal combustion engine;
maintaining engagement of the clutch in the slipping condition until the internal combustion engine rotates at a rotational speed that approximately corresponds to a rotational speed of the electric motor;
completely engaging the clutch when rotational speed of the internal combustion engine approximately corresponds to the rotational speed of the electric motor; and
completely re-engaging the transmission starting element when a difference between a rotational speed of the drive output and the rotational speed of one of the internal combustion engine and the electric motor is at least equal to a specified value.
